(19) United States
(12) Patent Application Publication
(10) Pub. No.: US 2024/0406824 A1
(43) Pub. Date: Dec. 5, 2024

(54) CELL RESELECTION METHOD

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 18/798,465

(22) Filed: Aug. 8, 2024

Related U.S. Application Data
(63) Continuation of application No. PCT/JP2023/003784, filed on Feb. 6, 2023.

(30) Foreign Application Priority Data
Feb. 9, 2022 (JP) 2022-018787

(51) Int. Cl. H04W 36/08; H04W 36/00; H04W 84/04

(52) U.S. Cl. CPC H04W 36/08; H04W 36/0061; H04W 84/042

(57) ABSTRACT

In a first aspect, a cell reselection method is performed in a mobile communication system. The cell reselection method includes acquiring, by a user equipment, slice frequency information indicating a correspondence relationship between a network slice, a frequency, and a frequency priority from a network node. The cell reselection method includes measuring, by the user equipment, the frequency. In addition, the cell reselection method includes: excluding, by the user equipment, the frequency in the network slice from a target of slice-specific cell reselection as a result of measuring the frequency, when a highest ranked cell in the frequency does not support the network slice. In addition, the cell reselection method includes performing, by the user equipment, the slice-specific cell reselection.

### RELATED APPLICATIONS

The present application is a continuation based on PCT Application No. PCT/JP2023/003784, filed on Feb. 6, 2023, which claims the benefit of Japanese Patent Application No. 2022-018787 filed on Feb. 9, 2022. The content of which is incorporated by reference herein in their entirety.

### TECHNICAL FIELD

The present disclosure relates to a cell reselection method in a mobile communication system.

### BACKGROUND

In specifications of The Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP TS 38.300 V16.8.0 (2021-12)

### SUMMARY

In a first aspect, a cell reselection method is performed in a mobile communication system. The cell reselection method includes acquiring, by a user equipment, slice frequency information indicating a correspondence relationship between a network slice, a frequency, and a frequency priority from a base station. The cell reselection method includes measuring, by the user equipment, the frequency. In addition, the cell reselection method includes: excluding, by the user equipment, the frequency in the network slice from a target of slice-specific cell reselection as a result of measuring the frequency, when a highest ranked cell in the frequency does not support the network slice. In addition, the cell reselection method includes performing, by the user equipment, the slice-specific cell reselection.

In a second aspect, a cell reselection method is performed in a mobile communication system. The cell reselection method includes transmitting, by a base station, slice non-supporting cell information indicating presence of a cell not supporting a network slice in a frequency included in slice frequency information indicating a correspondence relationship between the network slice, the frequency, and a frequency priority. The cell reselection method includes performing, by a user equipment, slice-specific cell reselection, based on the slice non-supporting cell information.

In a third aspect, a cell reselection method is performed in a mobile communication system. The cell reselection method includes transmitting, by a base station, slice support status information indicating whether network slices supported by cells are all identical in a predetermined range larger than a cell range. The cell reselection method includes performing, by a user equipment, slice-specific cell reselection, based on the slice support status information.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram illustrating an example of slice frequency information.

FIG. 11 is a flowchart illustrating a basic flow of the slice-specific cell reselection procedure.

FIG. 12 is a diagram illustrating an operation example according to the first embodiment.

FIG. 13 is a diagram illustrating an example of slice priority information and slice frequency information according to the first embodiment.

FIG. 14A and FIG. 14B are diagrams illustrating examples of order of priority according to the first embodiment.

FIG. 15A and FIG. 15B are diagrams illustrating examples of slice non-supporting cell information according to a second embodiment.

FIG. 16 is a diagram illustrating an operation example according to a second embodiment.

FIG. 17A is a diagram illustrating an example of Homogeneous according to a third embodiment, and FIG. 17B is a diagram illustrating an example of Heterogeneous according to the third embodiment.

FIG. 18A and FIG. 18B are diagrams illustrating operation examples according to the third embodiment.

### DESCRIPTION OF EMBODIMENTS

A user equipment in a radio resource control (RRC) idle state or an RRC inactive state performs a cell reselection procedure. In the 3GPP, slice-specific cell reselection that is a network slice-dependent cell reselection procedure is under study.

In an aspect, an object is to allow efficient slice-specific cell reselection to be performed. In an aspect, an object is to reduce power consumption of a user equipment.

A mobile communication system according to an embodiment is described with reference to the drawings. In the description of the drawings, the same or similar parts are denoted by the same or similar reference signs.

### First Embodiment

### Configuration of Mobile Communication System

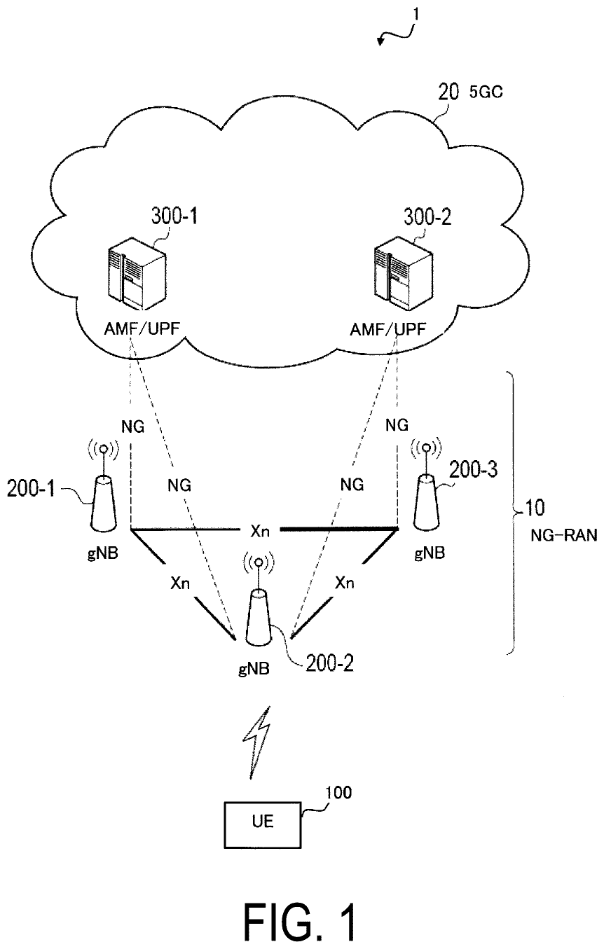

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF 300 performs various types of mobility controls and the like for the UE 100. The AMF 300 manages mobility of the UE 100 by communicating with the UE 100 by using Non-Access Stratum (NAS) signaling. The UPF controls data transfer. The AMF and the UPF 300 are connected to the gNB 200 via an NG interface being an interface between the base station and the core network.

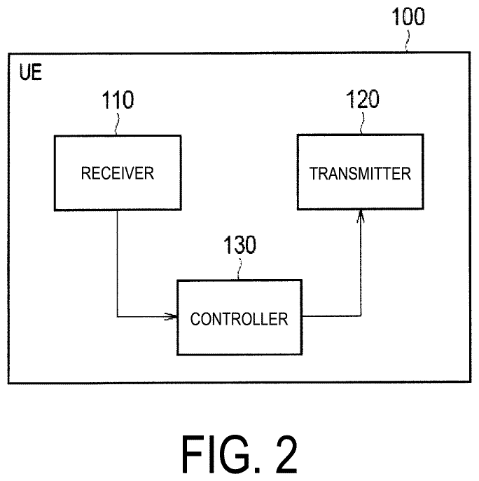

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

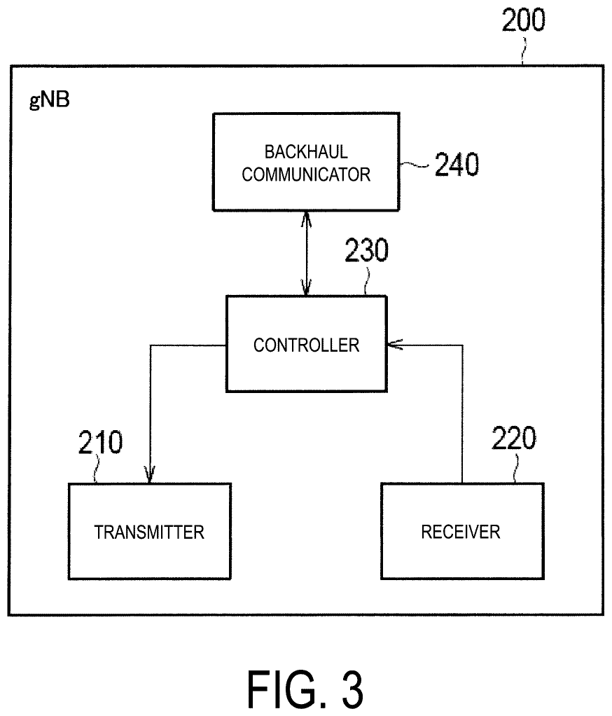

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

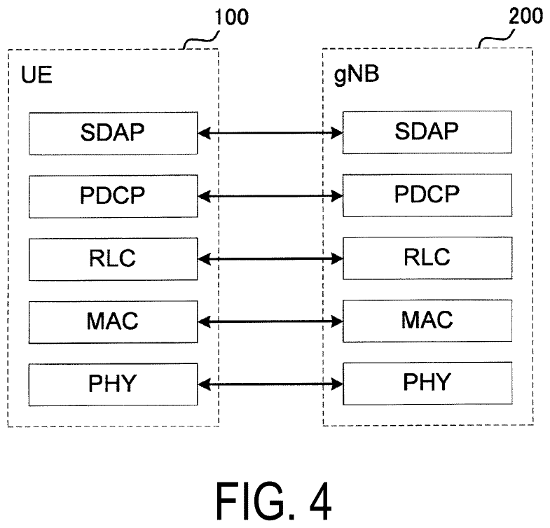

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP may not need to be provided.

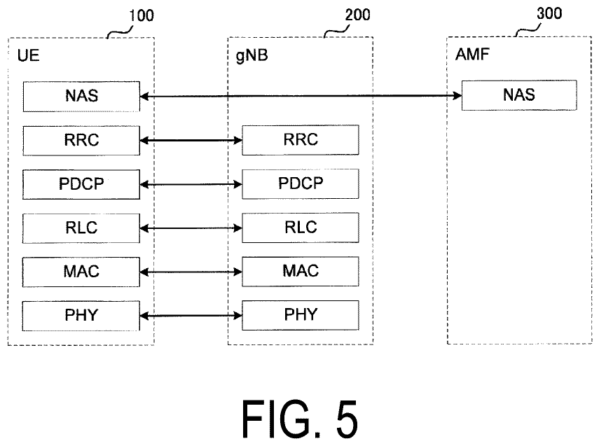

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### Overview of Cell Reselection Procedure

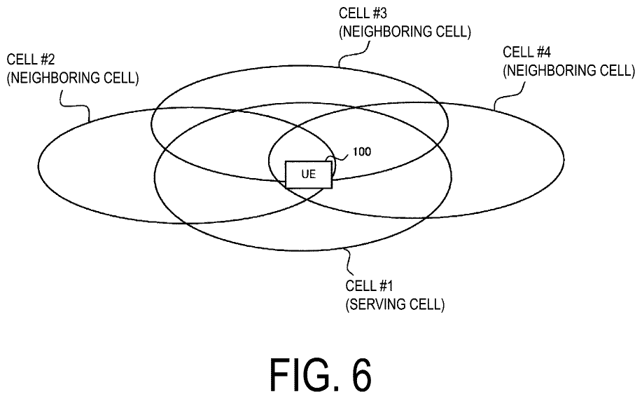

FIG. 6 is a diagram illustrating an overview of a cell reselection procedure.

The UE 100 in the RRC idle state or the RRC inactive state performs the cell reselection procedure with moving to migrate from a current serving cell (cell #1) to a neighboring cell (any one of cells #2 to #4). To be more specific, the UE 100 specifies a neighboring cell to be camped by the UE 100 through the cell reselection procedure and reselects the specified neighboring cell. When the frequency (carrier frequency) is the same between the current serving cell and the neighboring cell, it is referred to as an intra-frequency, and when the frequency (carrier frequency) is different between the current serving cell and the neighboring cell, it is referred to as an inter-frequency. The current serving cell and the neighboring cell may be managed by the same gNB 200. The current serving cell and the neighboring cell may be managed by the gNBs 200 different from each other.

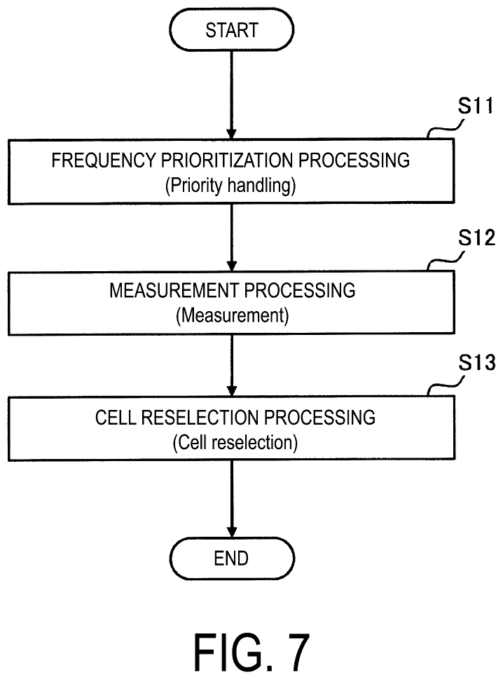

FIG. 7 is a flowchart illustrating a schematic flow of a typical (or legacy) cell reselection procedure.

In step S11, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 always measures the radio quality for frequencies having a higher priority than the frequency of the current serving cell, and for frequencies having a priority equal to or lower than the priority of the frequency of the current serving cell, and measures the radio quality of the frequency having the priority equal to or lower than the priority of the frequency of the current serving cell when the radio quality of the current serving cell is below a predetermined quality.

In step S13, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the frequency of the neighboring cell has a lower priority than the frequency of the current serving cell, the radio quality of the current serving cell is lower than a certain threshold value, and the radio quality of the neighboring cell is continuously higher than another threshold value for the predetermined period of time, the UE 100 may perform cell reselection to reselect the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

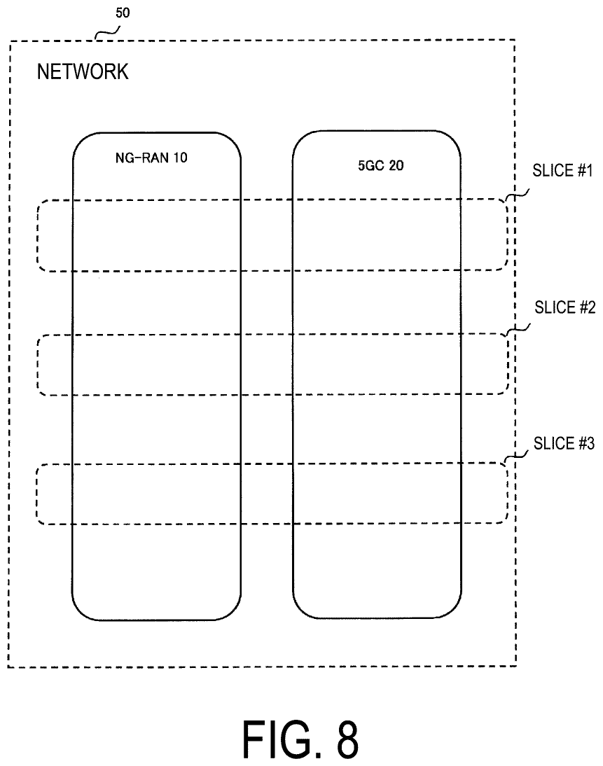

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI.

The UE 100 determines a desired slice that the UE 100 desires to use. The desired slice may be referred to as an “Intended slice”. In the first embodiment, the UE 100 determines a slice priority for each network slice (desired slice). For example, the NAS of the UE 100 determines the slice priority based on an operation status of an application in the UE 100 and/or a user operation/setting, and notifies the AS of slice priority information indicating the determined slice priority.

### Overview of Slice-Specific Cell Reselection Procedure

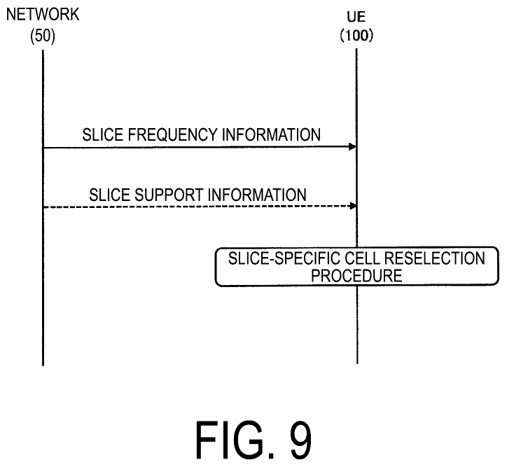

FIG. 9 is a diagram illustrating an overview of a slice-specific cell reselection procedure.

In the slice-specific cell reselection procedure, the UE 100 performs cell reselection processing based on slice frequency information provided from the network 50. The slice frequency information may be provided from the gNB 200 to the ULE 100 through broadcast signaling (for example, a system information block) or dedicated signaling (for example, an RRC release message).

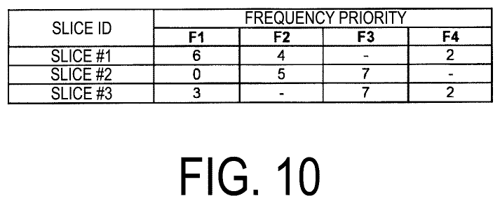

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

As illustrated in FIG. 9, the UE 100 may perform the cell reselection processing, further based on slice support information provided from the network 50. The slice support information may be information indicating a correspondence relationship between a cell (for example, a serving cell and each neighboring cell) and a network slice that is not provided or provided by the cell. For example, a cell may temporarily fail to provide some or all network slices due to congestion or the like. That is, even for a slice support frequency capable of providing a network slice, some cells within the frequency may not provide the network slice. Based on the slice support information, the UE 100 may recognize which network slice is not provided by each cell. Such slice support information may be provided from the gNB 200 to the UE 100 through broadcast signaling (for example, a system information block) or dedicated signaling (for example, an RRC release message).

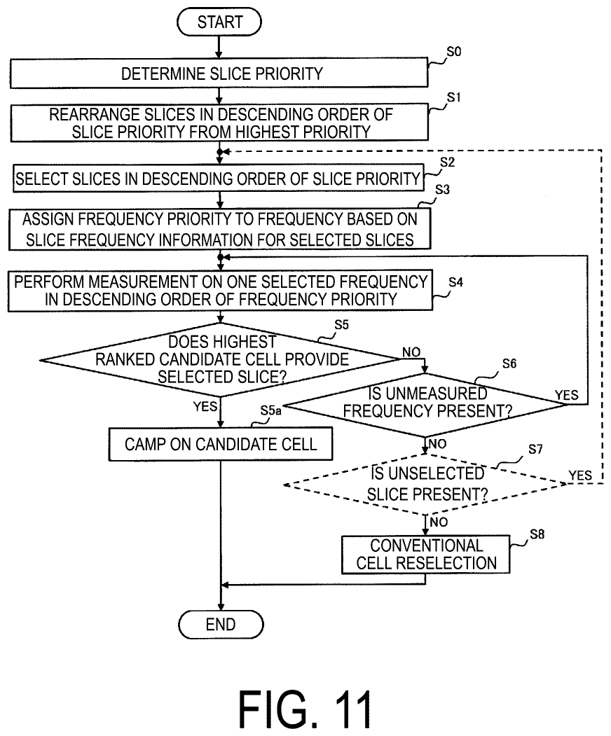

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information. Note that the “slice-specific cell reselection procedure” indicates a procedure of “slice-specific cell reselection”. Note that, in the following, “slice-specific cell reselection” and the “slice-specific cell reselection procedure” may be used in the same sense.

In step S0, the NAS of UE 100 determines the slice identifiers of the desired slices for the UE 100 and the slice priorities of the desired slices, and notifies the AS of the UE 100 of slice priority information including the determined slice priorities. The “desired slice” is the “Intended slice”, and includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a highest ranked cell based on results of the measurement processing in step S4, and determines whether the cell provides the selected network slice based on the slice support information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. In other words, the AS of the UE 100 determines whether a frequency to which the frequency priorities have been assigned in step S3 other than the selected frequency is present in the selected network slice. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. In other words, the AS of the UE 100 may determine whether a network slice other than the selected network slice is contained in the slice list. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of the typical (or legacy) cell reselection procedure illustrated in FIG. 7. The conventional cell reselection processing may also mean only cell reselection processing (step S30) illustrated in FIG. 7. In the latter case, the UE 100 may use the measurement result in step S4 without measuring the radio qualities of the cells again.

### Cell Reselection Method According to First Embodiment

As described above, in the slice-specific cell reselection (which may be slice aware cell reselection) procedure, the UE 100 performs measurement processing on the selected frequency in the selected network slice (step S4 of FIG. 11). Then, as a result of the measurement processing, the UE 100 determines whether the cell of the highest rank (that is, one of the neighboring cells for the serving cell) supports the selected network slice (step S5 of FIG. 11). In this case, the UE 100 determines whether the cell of the highest rank supports the selected network slice, using network slice information.

The network slice information is basically transmitted from the serving cell of the UE 100. That is, the serving cell transmits the slice support information of the neighboring cell (that is, including the cell of the highest rank as well), using broadcast signaling or dedicated signaling. The UE 100 acquires the slice support information, and determines step S5.

However, in some cases, the network slice information is not transmitted from the serving cell. This is because, in 3GPP, transmission of the network slice information from the serving cell is agreed upon but is optional.

When the network slice information is not transmitted from the serving cell, in step S5 of the slice-specific cell reselection procedure, for example, the UE 100 may perform processing of acquiring the slice support information from the neighboring cell or the like.

However, performing the processing of acquiring the slice support information from the neighboring cell while performing the slice-specific cell reselection procedure may affect a processing time of the slice-specific cell reselection procedure. It may also affect power consumption of the UE 100.

In view of this, the first embodiment has an object to enable cell reselection to be efficiently performed. The first embodiment has an object to reduce power consumption of the UE 100.

Thus, in the first embodiment, before performing the slice-specific cell reselection procedure, the UE 100 performs measurement of frequency(ies) (one or a plurality of frequencies) based on the slice frequency information. Then, when the cell of the highest rank in the frequency(ies) does not support the network slice, the UE 100 excludes the frequency(ies) from the target of slice-specific cell reselection. The UE 100 performs the slice-specific cell reselection procedure, with the frequency(ies) being excluded.

Specifically, firstly, the user equipment (for example, the UE 100) acquires network slice frequency information indicating a correspondence relationship between the network slice, the frequency, and the frequency priority from the base station (for example, the gNB 200). Secondly, the user equipment measures the frequency. Thirdly, when the cell having the highest rank in the frequency does not support the network slice as a result of measurement of the frequency, the user equipment excludes the frequency in the network slice from the target of slice-specific cell reselection. Fourthly, the user equipment performs slice-specific cell reselection.

Thus, for example, the cell not supporting the network slice in the frequency is excluded from the target of slice-specific cell reselection, and accordingly the cell of the highest rank all supports the selected network slice. Thus, in the slice-specific cell reselection procedure, whether the cell of the highest rank supports the selected network slice may not need to be checked. Thus, efficiency in processing of cell reselection can be improved. In the slice-specific cell reselection procedure, whether the cell of the highest rank supports the selected network slice may not need to be checked, and therefore power consumption of the UE 100 in cell reselection can also be reduced as compared to when the checking is performed.

### Operation Example According to First Embodiment

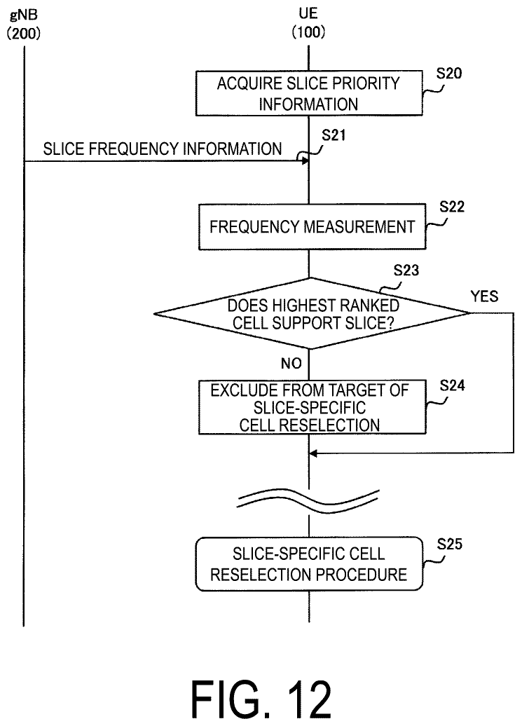

FIG. 12 is a diagram illustrating an operation example according to the first embodiment.

As illustrated in FIG. 12, in step S20, the UE 100 acquires the slice priority information. For example, the NAS of the UE 100 outputs the slice priority information to the AS of the UE 100, and the UE 100 acquires the slice priority information. As described above, the slice priority information is information indicating the slice priority for each desired slice.

In step S21, the UE 100 acquires the slice frequency information from the gNB 200. As described above, the slice frequency information is information indicating a correspondence relationship between the network slice, the frequency, and the frequency priority.

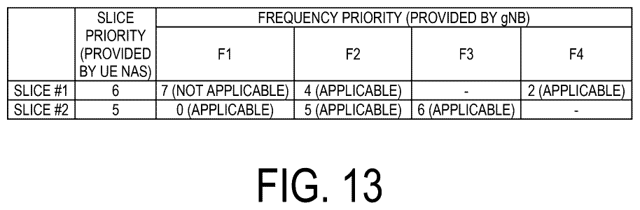

FIG. 13 is a diagram illustrating an example of the slice priority information and the slice frequency information according to the first embodiment. In the example illustrated in FIG. 13, as the slice priority information, the slice priority “6” for slice #1 and the slice priority “5” for slice #2 are indicated. As the slice frequency information, three frequencies, namely the frequencies F1, F2, and F4, are associated with slice #1. As the slice frequency information, the priority “7” of F1, the priority “4” of F2, and the priority “2” of F3 are indicated. In addition, as the slice frequency information, the frequencies F1, F2, and F3 are associated with slice #2. As the slice frequency information, the priority “0” of F1, the priority “5” of F2, and the priority “6” of F3 are indicated.

In FIG. 12, the order of step S20 and step S21 may be reversed.

In step S22, the UE 100 measures the frequency. When Discontinuous Reception (DRX) control is performed, the UE 100 may measure the frequency when DRX is off. A target to be measured is the frequency included in the slice frequency information. In the example of FIG. 13, the UE 100 measures F1, F2, F3, and F4. Note that the UE 100 may not need to measure all of the frequencies included in the slice frequency information. The target to be measured may be a frequency (that is, intra-frequency) the same as the frequency of the serving cell. The target to be measured may be a frequency (that is, inter-frequency) different from the frequency of the serving cell. In addition, the target to be measured may be a frequency having a frequency priority, which is a frequency priority larger than a first frequency priority threshold, among frequencies the same as the frequency of the serving cell. In addition, the target to be measured may be a frequency having a frequency priority, which is a frequency priority larger than a second frequency priority threshold, among frequencies different from the frequency of the serving cell. The first frequency priority threshold and the second frequency priority threshold may be the same value or may be different values. In addition, the frequency as the target to be measured may be selected among the frequencies included in the slice frequency information, based on received power (for example, Reference Signal Received Power (RSRP)) and received quality (for example, Reference Signal Received Quality (RSRQ)) of the frequency of the serving cell. Note that the frequency as the target to be measured may be hereinafter referred to as a “measurement frequency”.

Note that the UE 100 may perform step S22 after a certain period of time has elapsed. The certain period of time may be configured from the gNB 200. For example, when the gNB 200 configures 10 seconds, the UE 100 may start a timer with the configuration (10 seconds) being set at the time of performing step S22. When the timer expires, the UE 100 performs step S22 again.

Alternatively, in response to reception of an indication to perform step S22 from the gNB 200, the UE 100 may perform step S22 again. For example, when the gNB 200 changes a slice support status of a neighboring cell, the gNB 200 transmits the indication to the UE 100. When the UE 100 performs step S22 again, the UE 100 can follow the change of the slice support status of the neighboring cell.

In step S23, as a result of measurement in the measurement frequency, the UE 100 determines whether the cell of the highest rank supports the network slice. In this case, when the serving cell provides the slice support information of the neighboring cell, the UE 100 determines whether the cell of the highest rank supports the network slice, based on the slice support information. That is, the UE 100 receives the slice support information of the neighboring cell from the serving cell, and determines presence or absence of support, based on the slice support information. On the other hand, when the serving cell does not provide the slice support information of the neighboring cell, the UE 100 acquires the slice support information of the neighboring cell from a system information block (SIB) broadcast from the cell of the highest rank (that is, one of the neighboring cells). That is, the UE 100 receives the slice support information of the neighboring slice from the cell of the highest rank, and determines presence or absence of support, based on the slice support information.

When the UE 100 determines that the cell of the highest rank does not support the network slice in the measurement frequency (NO in step S23), the processing proceeds to step S24. On the other hand, when the UE 100 determines that the cell of the highest rank supports the network slice in the measurement frequency (YES in step S23), the processing proceeds to step S25.

Note that slice support determination when the slice-specific cell reselection procedure is performed may be omitted by storing slice support determination result information indicating slice support determination results in the memory in advance and then separately reading the slice support determination result information from the memory when the slice-specific cell reselection procedure is performed.

In step S24, the UE 100 excludes the measurement frequency from the target of slice-specific cell reselection. That is, when the cell having the highest rank does not support the network slice in the measurement frequency, the UE 100 excludes the frequency in the network slice from the target of slice-specific cell reselection. The example of FIG. 13 illustrates an example in which the cell having the highest rank does not support slice #1 in the measurement frequency F1, and thus F1 in slice #1 is excluded from the target of slice-specific cell reselection.

Referring back to FIG. 12, in step S25, the UE 100 performs the slice-specific cell reselection procedure. That is, when the cell of the highest rank in the measurement frequency does not support the network slice (NO in step S23), the UE 100 performs the slice-specific cell reselection procedure, with the measurement frequency being excluded. In the example of FIG. 13, the UE performs the slice-specific cell reselection procedure, with the frequency F1 in slice #1 being excluded. On the other hand, when the cell of the highest rank in the measurement frequency supports the desired slice (YES in step S23), the UE 100 performs the slice-specific cell reselection procedure, without excluding the measurement frequency. In the example of FIG. 13, the UE 100 performs the slice-specific cell reselection procedure, without excluding frequencies other than the frequency F1 in slice #1. Note that, when the network slice is not supported in any of the frequencies, the UE 100 performs typical (legacy) cell reselection.

Note that the slice support determination processing (step S20 to step S24) and the slice-specific cell reselection procedure (step S25) may be performed at predetermined timings. For example, in a phase in which electric field intensity of the serving cell does not require cell reselection, the UE 100 checks presence or absence of slice support in the neighboring cell (step S23), and stores the slice support determination result information indicating the results in the memory in advance. Then, in a phase in which the electric field intensity of the serving cell requires cell reselection, the UE 100 performs the slice-specific cell reselection procedure (step S25), using the slice support determination result information stored in the memory.

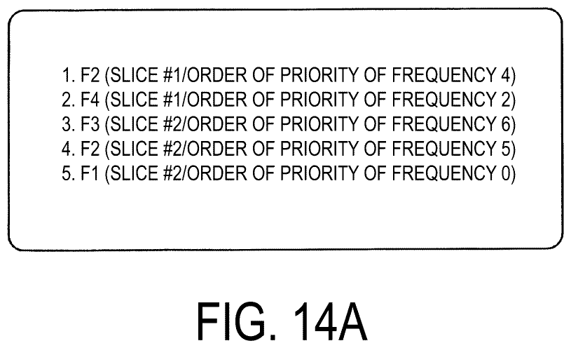

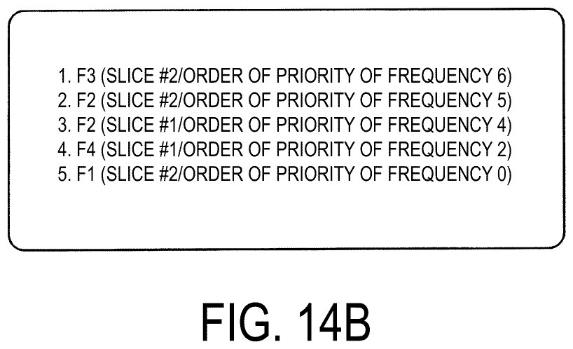

FIG. 14A is a diagram illustrating an example of order of priority according to the first embodiment. FIG. 14A illustrates an example of order of priority after the exclusion processing (step S24 of FIG. 12). As illustrated in FIG. 14A, the frequency F1 in slice #1 is excluded through the exclusion processing, and thus the order of priority of other frequencies included in the slice frequency information is illustrated.

On the other hand, FIG. 14B also illustrates an example of order of priority according to the first embodiment. FIG. 14B illustrates an example of order of priority with reference to the frequency priority included in the slice frequency information. To enable performing of the slice-specific cell reselection procedure with as little repeated operation as possible, for example, as illustrated in FIG. 14B, the UE 100 may perform the procedure, based on the order of priority with reference to the frequency priority. Alternatively, the UE 100 may perform the slice-specific cell reselection procedure by interchanging the order of priority illustrated in FIG. 14A and the order of priority illustrated in FIG. 14B as appropriate.

In the example of FIG. 14A, the UE 100 may perform cell reselection on the cell of the highest rank in the frequency F2. In the example of FIG. 14B, the UE 100 may perform cell reselection on the cell of the highest rank in the frequency F3.

Note that, when the UE 100 excludes the measurement frequency in the desired slice (step S24 of FIG. 12), the UE 100 may cancel the exclusion of the measurement frequency. In this case, the UE 100 performs the slice-specific cell reselection procedure without excluding the measurement frequency. This is because, for example, along with movement of the UE 100, a radio state may also change, the cell of the highest rank in the measurement frequency may change, and the cell may support the network slice.

Firstly, the UE 100 may enable the exclusion processing (step S24) until the cell of the highest rank is changed, and when it is changed, the UE 100 may cancel the exclusion. Note that the cell of the highest rank before being changed may be reselected through legacy cell reselection although the cell does not support the network slice. Thus, the UE 100 may perform measurement of received power and received quality for the (original) cell of the highest rank even after canceling the exclusion.

Secondly, the UE 100 may enable the exclusion until its immediately following slice-specific cell reselection procedure (step S25 of FIG. 12), and may cancel the exclusion at the time of its following slice-specific cell reselection procedure.

Thirdly, the UE 100 may configure time until cancelation, using a timer or the like. Fourthly, cancelation may be performed with a trigger of a change of the position of the UE 100.

Fifthly, the UE 100 may configure some sort of number of times before cancelation. For example, it may be the number of times based on a paging period, and cancelation may be performed in 2.56 (s)×n times (n is a natural number). For example, when presence or absence of slice support is checked regarding the cell of the highest rank, presence or absence of slice support may or may not need to be checked for the time described above.

### Second Embodiment

A second embodiment will be described.

The first embodiment has described an example in which, when the cell of the highest rank does not support the network slice in the frequency included in the slice frequency information, the frequency is excluded in slice-specific cell reselection. In this case, the UE 100 determines whether the cell of the highest rank supports the network slice in the frequency, based on the slice support information (step S23 of FIG. 12).

In contrast, the second embodiment is an example in which, when the cell not supporting the network slice is present in the frequency included in the slice frequency information, the gNB 200 notifies the UE 100 of the situation. That is, it is an example in which a cell not supporting a specific network slice is present among cells supporting the frequency, and the gNB 200 notifies the UE 100 of presence of such a cell in the frequency. In this manner, the cell not supporting the network slice in the frequency may be referred to as a “slice non-supporting cell”. Information indicating presence of the cell not supporting the network slice in the frequency may be referred to as “slice non-supporting cell information”. The second embodiment is an embodiment in which the gNB 200 notifies the UE 100 of the slice non-supporting cell information.

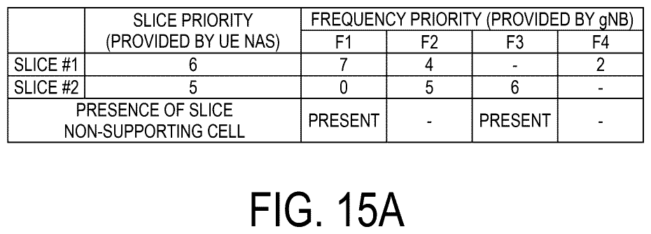

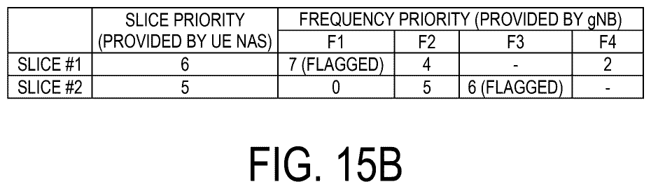

FIG. 15A is a diagram illustrating an example of the slice non-supporting cell information according to the second embodiment. In the example of FIG. 15A, it is indicated that the slice non-supporting cells are present regarding F1 and F3 among the frequencies F1, F2, F3, and F4 included in the slice frequency information. That is, regarding F1, presence of a cell not supporting a slice, i.e., slice #1 and/or slice #2, is indicated. Regarding F3, presence of a cell not supporting slice #2 is indicated. In the example of FIG. 15A, presence of the slice non-supporting cell is indicated by a flag indicating presence of the slice non-supporting cell.

In contrast, as in F2 or F4, in the frequency in which the flag of the slice non-supporting cell is not present, it is indicated that all of the cells supporting the frequency support the network slice indicated by the slice priority information. In the example of FIG. 15A, regarding F2, it is indicated that all of the cells supporting F2 also support slice #1 and slice #2. Regarding F4, it is indicated that all of the cells supporting F4 support slice #1. Thus, when the UE 100 determines whether the cell of the highest rank supports the selected network slice in the slice-specific cell reselection procedure (step S5 of FIG. 11), the UE 100 may not need to check the slice support information regarding the frequency in which the flag of the slice non-supporting cell is not present. This is because, regarding the frequency, the network slice is supported in all of the cells supporting the frequency (also including the cell of the highest rank), and thus the UE 100 may not need to check the slice support information. As has been described in the first embodiment as well, in some cases, the slice support information of the neighboring cell is not transmitted from the serving cell. However, the network slice is supported in all of the cells regarding the frequencies not indicated by the slice non-supporting cell information, and thus the UE can initiate the slice-specific cell reselection procedure even without the slice support information. Thus, in the second embodiment, efficiency in processing of cell reselection can be improved. The UE 100 may not need to check the slice support information in some cases, and thus power consumption can also be reduced as compared to when the slice support information is invariably checked.

FIG. 15B is also a diagram illustrating an example of the slice non-supporting cell information according to the second embodiment. The example of FIG. 15A is an example in which the slice non-supporting cell information is associated with a plurality of network slices, whereas FIG. 15B illustrates an example in which the slice non-supporting cell information is associated with a single network slice (or for each network slice). In the example of FIG. 15B, regarding the frequency F1, presence of the cell not supporting slice #1 is indicated. In the example of FIG. 15B, regarding the frequency F3, presence of the cell not supporting slice #2 is indicated. In contrast, in the same frequency F1, regarding slice #2, support of slice #2 in all of the cells is indicated. That is, in the case illustrated in FIG. 15B as well, in a manner the same as and/or similar to the case illustrated in FIG. 15A, in the frequencies not indicated by the slice non-supporting cell information, support of the network slice in all of the cells is indicated. Thus, in the slice-specific cell reselection procedure, for example, the UE 100 may not need to check whether the cell of the highest rank in the frequency F1 supports slice #1 from the slice support information. Therefore, efficiency of slice-specific cell reselection can be improved. Power consumption of the UE 100 can be reduced.

In this manner, in the second embodiment, specifically, firstly, the base station (for example, the gNB 200) transmits the slice non-supporting cell information indicating presence of the cell not supporting the network slice in the frequency included in the slice frequency information indicating a correspondence relationship between the network slice, the frequency, and the frequency priority. Secondly, the user equipment (for example, the UE 100) performs the slice-specific cell reselection procedure, based on the slice non-supporting cell information.

Thus, as described above, regarding the frequencies not indicated by the slice non-supporting cell information, the slice support information may not need to be checked, and therefore efficiency in processing of cell reselection can be improved. Regarding the frequencies not indicated by the slice non-supporting cell information, the slice support information may not need to be checked, and therefore power consumption of the UE 100 can also be reduced.

### Operation Example According to Second Embodiment

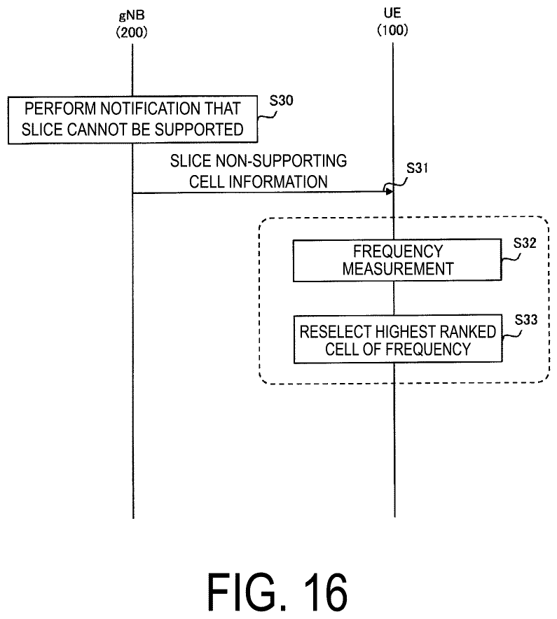

FIG. 16 is a diagram illustrating an operation example according to the second embodiment. Note that, before performing the processing illustrated in FIG. 16, the UE 100 receives the slice frequency information from the gNB 200. Before performing the processing illustrated in FIG. 16, the AS of the UE 100 receives the slice priority information from the NAS of the UE 100.

As illustrated in FIG. 16, in step S30, when the cell of the gNB 200 cannot support its slice(s), the cell notifies the gNB 200 of the inability to support. For example, the DU of the gNB 200 notifies the CU of the gNB 200 of the inability. Examples of reasons for the inability to support include a high load of the cell.

In step S31, the gNB 200 transmits the slice non-supporting cell information. The slice non-supporting cell information includes information indicating presence of the cell not supporting the network slice regarding the frequency included in the slice frequency information. The slice non-supporting cell information may be included in the slice frequency information. The slice non-supporting cell information may be transmitted together with the slice frequency information. The slice non-supporting cell information may be associated with the frequency included in the slice frequency information. That is, as illustrated in FIG. 15A, the slice non-supporting cell information may be associated with a plurality of network slices. The slice non-supporting cell information may be associated with the network slice included in the slice priority information and the frequency included in the slice frequency information. That is, as illustrated in FIG. 15B, the slice non-supporting cell information may be associated for each network slice regarding each frequency. The slice non-supporting cell information may be broadcast using broadcast signaling (for example, a SIB). The slice non-supporting cell information may be transmitted using dedicated signaling (for example, an RRC release message).

Note that the slice non-supporting cell information may be information indicating presence of a cell supporting the network slice. For example, in the example of FIG. 15A, when a flag indicating presence of the cell supporting the network slice is present in F1, it is indicated that the cell supporting F1 also supports slice #1 and slice #2. Regarding F2 in which the flag is not present, presence of the cell not supporting one of slice #1 and slice #2 in slice #1 and/or slice #2 among cells supporting F2 is indicated. For example, in the example of FIG. 15B, the flag is present in the frequency F1 corresponding to slice #1, and thus support of slice #1 in all of the cells supporting F1 is indicated. The flag is not present in the frequency F1 corresponding to slice #2, and thus presence of the cell not supporting slice #2 among cells supporting F1 is indicated.

The slice non-supporting cell information may include information indicating no presence of the cell supporting the network slice and information indicating presence of the cell supporting the network slice.

Referring back to FIG. 16, in step S32, the UE 100 measures the frequency included in the slice frequency information. When DRX control is performed, the UE 100 may measure the frequency when DRX is off. In this case, the UE 100 checks presence or absence of slice support, based on the slice non-supporting cell information. That is, the UE 100 checks presence or absence of slice support regarding the frequency in which the slice non-supporting cell is present, and does not check presence or absence of slice support regarding the frequencies other than the frequency. This is because, in the frequencies other than the frequency in which the slice non-supporting cell is present, all of the cells supporting the frequency support the network slice, and thus the slice support information may not need to be checked.

In step S33, the UE 100 reselects the highest ranked cell regarding the frequency being a target of measurement of the frequency.

Note that step S32 may be processing before the slice-specific cell reselection procedure in a manner the same as and/or similar to the frequency measurement (step S22 of FIG. 12) in the first embodiment, and step S33 may be processing during the slice-specific cell reselection procedure. Both of step S32 and step S33 may be processing during the slice-specific cell reselection procedure.

### Third Embodiment

A third embodiment will be described.

The third embodiment is an embodiment in which the slice support information is notified in a predetermined range larger than a cell. Specifically, firstly, the base station (for example, the gNB 200) transmits slice support status information indicating whether the network slices supported by the cells in the predetermined range larger than the cell are all the same. Secondly, the user equipment performs the slice-specific cell reselection procedure, based on the slice support status information.

As described above, the slice support information is transmitted by the serving cell. Thus, it can be considered that the slice support information is basically valid within the serving cell.

However, the slice support information may be all the same in a large range exceeding a cell range. For example, the network slices supported in a plurality of cells may be all the same.

In this manner, the network slices supported in the cells in the predetermined range being all the same may be referred to as “Homogeneous” (uniform).

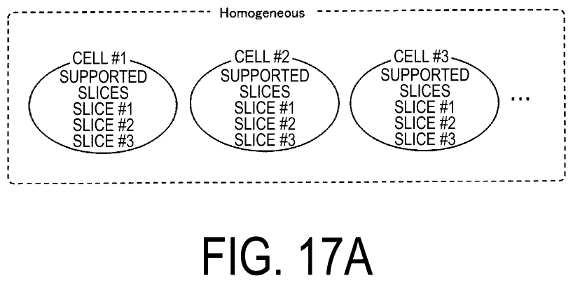

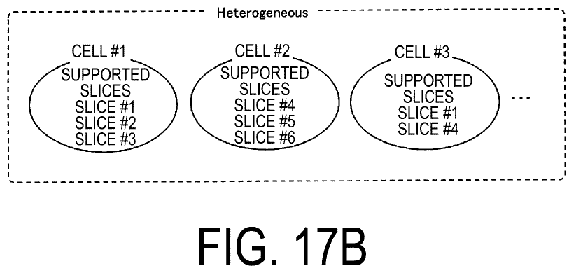

FIG. 17A is a diagram illustrating an example of Homogeneous according to the third embodiment. In the example illustrated in FIG. 17A, the network slices supported in cell #1 are slice #1, slice #2, and slice #3, the network slices supported in cell #2 are also slice #1, slice #2, and slice #3, and other cells are the same as and/or similar to this. In the predetermined range, the network slices supported by the cells are all the same, i.e., slice #1, slice #2, and slice #3. In Homogeneous, the same network slices may be supported in all of the frequencies in the predetermined range. Alternatively, Homogeneous may be a state in which a correspondence between the network slices supported in the predetermined range and the frequencies is uniform. In the latter case, for example, slice #1 and slice #2 are supported in the frequency F1 and slice #3 is supported in the frequency F2, and even when the correspondence relationship is the same in the predetermined range, it is Homogeneous.

In the predetermined range indicated as Homogeneous, slice support is all the same, and thus once the UE 100 checks, the UE 100 may not need to check presence or absence of slice support again in the predetermined range. Thus, in the UE 100, the number of times of checking (specifically, step S5 of FIG. 11) of presence or absence of slice support in the slice-specific cell reselection procedure can be reduced as compared to when all are checked. Therefore, efficiency in processing of cell reselection can be improved. Owing to the reduction in the number of times of checking of presence or absence of slice support, power consumption in the UE 100 can also be reduced.

Homogeneous indicates that the network slices supported by the cells are all the same in the predetermined range; however, in the predetermined range, the network slices supported by the cells may be different. In the predetermined range, the network slices supported by the cells being different may be referred to as “Heterogeneous” (mixed).

FIG. 17B is a diagram illustrating an example of Heterogeneous according to the third embodiment. In the example illustrated in FIG. 17B, the network slices supported in cell #1 are slice #1, slice #2, and slice #3, the network slices supported in cell #2 are slice #4, slice #5, and slice #6, and slice #1 and slice #4 are supported in cell #3. In this manner, in the predetermined range, the network slices supported by the cells are not the same. That is, Heterogeneous may be a state in which different network slices are supported in the frequencies in the predetermined range. Alternatively, Heterogeneous may be a state in which a correspondence relationship between the frequencies and the network slices in the predetermined range are not uniform.

Homogeneous may be Heterogeneous when the network slices are only partially different even though the supported network slices are all the same in all of the cells in the predetermined range. In the predetermined range, information indicating whether it is Homogeneous or Heterogeneous may be referred to as the “slice support status information”. The slice support status information may be information indicating whether it is Homogeneous in the predetermined range. The slice support status information may be information indicating whether it is Heterogeneous in the predetermined range.

Firstly, the predetermined range may be a Tracking Area (TA). The TA includes one or a plurality of cells, and indicates an area in which the UE 100 in the RRC idle state can move without updating MME. Once the UE 100 checks that it is Homogeneous via the slice support status information in the TA, the UE 100 may not need to check the slice support information in the same TA. Regarding the predetermined range, which TA is used as the predetermined range may be indicated by a Tracking Area Identity (TAI). Note that the predetermined range may include a plurality of TAs. In this case, the predetermined range may be indicated by presence of a plurality of TAIs of the TAs constituting the predetermined range.

Secondly, the predetermined range may be a Registration Area (RA). The RA includes one or a plurality of cells, and is defined as a set of TAs. The RA includes a plurality of TAs, and thus the number of times of transmission of registration update signaling can be further reduced than when the registration update signaling is transmitted for each TA. Once the UE 100 checks that it is Homogeneous via the slice support status information in the RA, the UE 100 may not need to check the slice support information in the same RA. Note that the RA can be distinguished from other RAs, based on a list of pieces of identification information (TAIs) of the TAs included in the RA. Thus, which RA is used as the predetermined range may be indicated by the list of TAIs. Note that the predetermined range may include a plurality of RAs. In this case, the predetermined range may be indicated by presence of a plurality of TAI lists of the RAs constituting the predetermined range.

Thirdly, the predetermined range may be a Public Land Mobile Network (PLMN). The PLMN indicates a range in which telecommunications carriers can provide services. Once the UE 100 checks that it is Homogeneous via the slice support status information in the PLMN, the UE 100 may not need to check the slice support information in the same PLMN. Regarding the predetermined range, which PLMN is used as the predetermined range may be indicated by a PLMN ID.

Fourthly, the predetermined range may be a RAN-based Notification Area (RNA). The RNA includes one or a plurality of cells, but is a range narrower than the TA. The RNA indicates an area in which the UE 100 in the RRC inactive state can move without performing notification to the NG-RAN 10. Once the UE 100 checks that it is Homogeneous via the slice support status information in the RNA, the UE 100 may not need to check the slice support information in the same RNA. Which RNA is used as the predetermined range may be indicated as the predetermined range, using some method for distinguishing the RNA from other RNAs. Regarding the RNA as well, the predetermined range may include a plurality of RNAs. In this case, the predetermined range may be indicated by presence of a plurality of pieces of identification information of the RNAs constituting the predetermined range.

Note that, as long as the predetermined range is an area including a plurality of cells, the predetermined range may not need to be the TA, the RA, the PLMN, and the RNA. For example, the predetermined range may be the gNB 200 that manages a plurality of cells. The predetermined range may be indicated by a cell list including a plurality of cells, for example.

The slice support status information can also be checked from the serving cell, and can also be checked from the neighboring cell.

The slice support status information may be configured with a term of validity. The term of validity may be valid within a range of Homogeneous. The term of validity may be valid within a range of Heterogeneous. The term of validity may be a term of validity different for each predetermined range. The term of validity may be the same term of validity in all of the predetermined ranges. For example, the term of validity may be a term of validity different for each TA, or may be the same term of validity in all of the TAs.

### Operation Example According to Third Embodiment

An operation example according to the third embodiment will be described.

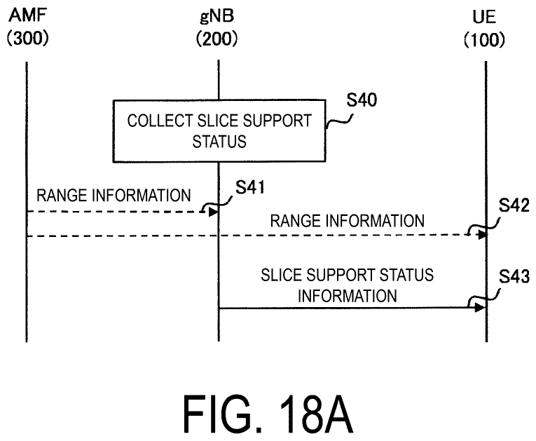

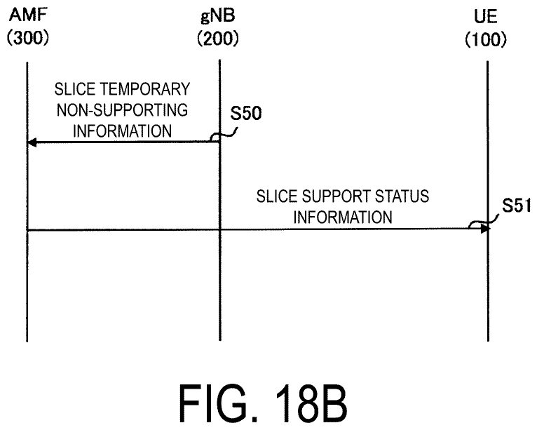

The slice support status information may be transmitted from the gNB 200 to the UE 100. The slice support status information may be transmitted from the AMF 300 to the UE 100. FIG. 18A is an example of transmission from the gNB 200 to the UE 100, and FIG. 18B is an example of transmission from the AMF 300 to the UE 100. FIG. 18A and FIG. 18B are each a diagram illustrating an operation example according to the third embodiment.

First, FIG. 18A will be described.

As illustrated in FIG. 18A, in step S40, the gNB 200 collects the slice support status. Examples of the slice support status are as follows.

Firstly, a cell may temporarily not support the network slice due to a reason such as a high load. In this case, the DU of the gNB 200 may transmit an F1 message including information indicating that the network slices are temporarily not supported to the CU, and thereby notification may be performed. The gNB 200 may notify a neighboring gNB of information that the network slices are temporarily not supported. For example, the gNB 200 may transmit an Xn message including the information to the neighboring gNB, and thereby notification may be performed.

Secondly, the network slices may be temporarily not supported due to a reason of deployment. In this case, due to a reason of deployment, an operator may determine to not support the network slices, and indicate to temporarily not support the network slices. For example, the AMF 300 may transmit an NG message including information indicating that the network slices are temporarily not supported to the gNB 200, and thereby notification may be performed. The AMF 300 may notify the gNB 200 of information not stored in the gNB 200 (for example, deployment information of the PLMN and the like) using the NG message in step S40.

Thirdly, the predetermined range is one of the TA, the RA, the PLMN, and the RNA. The predetermined range may be a combination of the TA, the RA, the PLMN, and the RNA. For example, the predetermined range may be indicated by RNA #1 and TA #1. The range information indicating the predetermined range may be transmitted from the AMF 300 to the gNB 200 (step S41). In this case, the AMF 300 may transmit an NG message including the range information to the gNB 200, and thereby notification may be performed. Note that the range information may be directly transmitted from the AMF 300 to the UE 100 (step S42). In this case, the AMF 300 may transmit a NAS message including the range information to the NAS of the UE 100, and the NAS of the UE 100 may notify the AS of the UE 100 of the range information.

In step S43, the gNB 200 creates the slice support status information, based on the collected slice support status, and transmits the slice support status information. The gNB 200 may broadcast the slice support status information, using broadcast signaling (for example, a SIB). The gNB 200 may transmit the slice support status information, using dedicated signaling (for example, an RRC release (RRCRelease) message). The slice support status information may include information indicating whether Homogeneous is indicated or Heterogeneous is indicated. As described above, the slice support status information may include information of Homogeneous, and may not need to include information indicating Heterogeneous. As described above, the slice support status information may include information indicating Heterogeneous, and may not need to include information of Homogeneous. In addition, as described above, the slice support status information may include information indicating the predetermined range (which may be information indicating the TA, the RA, the PLMN, or the RNA, or may be information indicating a combination of the TA, the RA, the PLMN, and the RNA). In addition, as described above, the slice support status information may include a term of validity.

In the case of FIG. 18B, when the gNB 200 temporarily does not support the network slices due to a reason such as a high load, the gNB 200 transmits slice temporary non-supporting information indicating that the network slices are temporarily not supported to the AMF 300 (step S50). The slice temporary non-supporting information may be transmitted being included in an NG message. In a manner the same as and/or similar to FIG. 18A, the AMF 300 may collect the slice support status, and acquire information not stored in the AMF 300 from the gNB 200 using an NG message.

Then, in step S51, the AMF 300 transmits the slice support status information to the UE 100, using a NAS message. For example, the AMF 300 may include the slice support status information in a registration accept message being a NAS message in a registration sequence of the NAS to transmit the slice support status information.

Both in the case of FIG. 18A and the case of FIG. 18B, the UE 100 receives the slice support status information. Then, the UE 100 can recognize whether it is Homogeneous or Heterogeneous in the predetermined range, based on the slice support status information. Then, when it is Homogeneous in the predetermined range, the UE 100 can perform the slice-specific cell reselection procedure without checking the slice support status information. Thus, even when the slice support status information of the neighboring cell is not transmitted from the serving cell, the slice-specific cell reselection procedure can be performed without acquiring the slice support status information from the neighboring cell. Therefore, the UE 100 can efficiently perform slice-specific cell reselection. The UE 100 can perform slice-specific cell reselection with reduced power consumption.

### Other Embodiments

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

Supplementary Note Features relating to the embodiments described above are described below as supplements.

(1)

A cell reselection method in a mobile communication system, the cell reselection method including:
acquiring, by a user equipment, slice frequency information indicating a correspondence relationship between a network slice, a frequency, and a frequency priority from a base station;
measuring, by the user equipment, the frequency;
excluding, by the user equipment, the frequency in the network slice from a target of slice-specific cell reselection as a result of measuring the frequency, when a highest ranked cell in the frequency does not support the network slice; and
performing, by the user equipment, the slice-specific cell reselection.
   (2)

The cell reselection method according to (1) above, wherein the excluding includes determining, by the user equipment, that the highest ranked cell does not support the network slice, based on slice support information indicating whether the cell provides the network slice.

(3)

The cell reselection method according to (1) or (2) above, wherein the user equipment receives the slice support information from a serving cell, or the user equipment receives the slice support information from the highest ranked cell.

(4)

The cell reselection method according to any one of (1) to (3) above, further including canceling, by the user equipment, the excluding of the frequency from the target of the slice-specific cell reselection.

(5)

A cell reselection method in a mobile communication system, the cell reselection method including:
transmitting, by a base station, slice non-supporting cell information indicating presence of a cell not supporting a network slice in a frequency included in slice frequency information indicating a correspondence relationship between the network slice, the frequency, and a frequency priority; and
performing, by a user equipment, slice-specific cell reselection, based on the slice non-supporting cell information.
   (6)

The cell reselection method according to (5) above, wherein
the performing includes performing, by the user equipment, the slice-specific cell reselection on a frequency other than the frequency indicated by the slice non-supporting cell information without checking whether a highest ranked cell supports the network slice.
   (7)

A cell reselection method in a mobile communication system, the cell reselection method including:
transmitting, by a base station, slice support status information indicating whether network slices supported by cells are all identical in a predetermined range larger than a cell range; and performing, by a user equipment, slice-specific cell reselection, based on the slice support status information.
   (8)

The cell reselection method according to (7) above, wherein
the slice support status information indicates that the network slices supported by the cells in the predetermined range are all identical, or
the slice support status information indicates that the network slices supported by the cells in the predetermined range are not identical.
   (9)

The cell reselection method according to (7) or (8) above, wherein the predetermined range is one of a Tracking Area (TA), a Registration Area (RA), and a Public Land Mobile Network (PLMN).

### REFERENCE SIGNS

1: Mobile communication system
20: 5GC
100: UE
110: Receiver
120: Transmitter
130: Controller
200: gNB
210: Transmitter
220: Receiver
230: Controller
300: AMF

1. A cell reselection method in a mobile communication system, the cell reselection method comprising the steps of:
transmitting, by a network node, slice non-supporting cell information indicating presence of a cell not supporting a network slice in a frequency comprised in slice frequency information indicating a correspondence relationship between the network slice, the frequency, and a frequency priority; and
performing, by a user equipment, slice-specific cell reselection, based on the slice non-supporting cell information.

2. The cell reselection method according to claim 1, wherein
the performing comprises performing, by the user equipment, the slice-specific cell reselection on a frequency other than the frequency indicated by the slice non-supporting cell information without checking whether a highest ranked cell supports the network slice.

3. A user equipment comprising
a receiver configured to receive from a network node, slice non-supporting cell information indicating presence of a cell not supporting a network slice in a frequency comprised in slice frequency information indicating a correspondence relationship between the network slice, the frequency, and a frequency priority, and
a controller configured to perform slice-specific cell reselection, based on the slice non-supporting cell information.

4. A cell reselection method in a mobile communication system, the cell reselection method comprising the steps of:
transmitting, by a network node, slice support status information indicating whether network slices supported by cells are all identical in a predetermined range larger than a cell range; and
performing, by a user equipment, slice-specific cell reselection, based on the slice support status information.

5. The cell reselection method according to claim 4, wherein
the slice support status information indicates that the network slices supported by the cells in the predetermined range are all identical, or
the slice support status information indicates that the network slices supported by the cells in the predetermined range are not identical.

6. The cell reselection method according to claim 4, wherein
the predetermined range is one of a Tracking Area (TA), a Registration Area (RA), and a Public Land Mobile Network (PLMN).
